(19) United States
(12) Patent Application Publication
(10) Pub. No.: US 2013/0049904 A1
(43) Pub. Date: Feb. 28, 2013

(54) TRIP UNIT

(71) Applicants: Aloysius Hemmer, Hengelo (NL); Ronaldus Niehoff, Oldenzaal (NL); Stefan Van Vlijmen, Almelo (NL)

(72) Inventors: Aloysius Hemmer, Hengelo (NL); Ronaldus Niehoff, Oldenzaal (NL); Stefan Van Vlijmen, Almelo (NL)

(73) Assignee: Eaton Industries (Netherlands) B.V., Hengelo (NL)

(21) Appl. No.: 13/497,901

(22) PCT Filed: Sep. 24, 2010
(86) PCT No.: PCT/EP2010/064169

§ 371 Date: Nov. 5, 2012

(30) Foreign Application Priority Data
Sep. 25, 2009 (GB) 0916862.6

(51) Int. Cl. H01H 83/02; H01H 11/00

(52) U.S. Cl. 335/15; 29/622

(57) ABSTRACT

A trip unit includes an actuator and a cylindrical housing container the actuator. The actuator includes a cylindrical pin; a cylindrical closed chamber; a biasing member; a permanent magnet; a coil housing; and a coil supported by the coil housing. The pin is axially movably disposed in the chamber and extends out of the chamber through a sealed opening. The biasing member may comprise a spring, such as a helical spring, and may be configured to bias the pin for an axial movement in a direction out of the chamber. The permanent magnet may at least partly surround the pin during a latched condition of the trip unit. The coil housing may at least partly define the cylindrical closed chamber. In embodiments, an annular gap is provided between the pin and the permanent magnet. Methods associated with the manufacturing trip units are also disclosed.

### FIELD OF THE INVENTION

The present invention relates to a trip unit for an earth leakage detection device to switch off a mechanism or load.

### State of the Art

Earth leakage detection devices are safety devices. Whenever an earth leakage is detected, an electrical circuit is interrupted in the sense of switching off the current in that electrical circuit which causes failures like destruction due to electrical current in other electrical parts where current is not supposed to be present or to persons acting with conductive materials energised by malfunction of the system.

It is desirable to reduce the size or volume of a tip unit in order to be able to also reduce the earth leakage detection device in which the trip unit is assembled. In this way more earth leakage detection devices can be built in a predetermined space, for example a consumer unit, resulting in extended possibilities for protecting the associated electric circuit and/or persons in the surroundings thereof.

It is generally known that iron wear contaminates contact surfaces and therefore deteriorates their magnetic behaviour. In a trip unit this can lead to undesirable effects. As another source of contamination, typically dust comes from the environment. Trip units with relatively large housing volumes have large magnets which in general have bigger fields. Larger fields have more influence on attracting iron particles to the interior of the trip unit. Large housing volumes also lead to bigger housing openings; hence, higher probability that contamination particles (such as dust and iron particles from moving parts of the earth leakage detection device) enter into the housing of the trip unit and affects electrical properties or might cause the moving parts of the actuating unit to get stuck. For example, in FR 2 897 979 it is the aim to prevent the intrusion of contaminating on a contact surface between a core or piston and a stator of an actuator by providing an additional flexible body. The piston has been extended outwardly from an opening in a housing of the actuator to accommodate a release spring outside of the housing surrounding the piston. The flexible body covers the release spring and seals in this way the opening in the housing. In order to counteract the resistance of the flexible body when resetting the actuator, an additional resetting spring is arranged around the outer end of the piston.

Furthermore, in the prior art, actuation signals generated by a sensor coil and transmitted by an electronic device are in general not adjustable. This means if there is a need to tune the tripping level of the actuator, this can only be done by changing the magnetic field produced by a permanent magnet, requiring access to the interior of the trip unit.

Since these actuators are solenoids, this leads to another disadvantage in that, in order to achieve a specific optimal electrical and magnet behaviour, conventional solenoid coil cores and stator parts are manufactured from FeNi 50-50. This material has the required magnetic properties (i.e. low resistance for magnetic field) but the disadvantage is that this material is rather expensive.

The present invention seeks to solve one or more of the above as well as further problems of the conventional earth leakage circuit breakers.

### SUMMARY OF THE INVENTION

The present application provides a trip unit as set forth in claim 1. Preferred embodiments may be gathered from the dependent claims. The closed housing is protecting the movable parts of the actuator inside the housing from iron wear and dust particles entering into the actuator. It further contains the actuator which has only one opening for the pin movement. This so called tripping opening accommodates a plastic bearing and is reduced to a minimum by exploiting the advantages of a linear movement of the pin inside a circular chamber and the shape of the pin which is circular too. Both of these attributes are resulting in small dimensions.

The coil core and stator part of the actuation unit are manufactured of iron, in contrast to prevalently used expensive Fe—Ni alloy material.

The accumulating iron wear is kept away from the magnetic surfaces by placing the permanent magnet in an advantageous position at the bottom of the closed housing.

The volume of the trip unit of the present invention is only about one third compared to the prior art. The small design of the trip unit of the present invention leads to all the advantages over the prior art like minimized tripping openings or smaller magnets described in the section of the state of the art. Moreover the reduced volume enables the use of smaller circuit breakers, in which the trip unit is incorporated.

The chosen design for the present application however can be easily adapted to decreasing or increasing application dimensions resulting in different specification parameters in which for instance different trip forces are needed.

In one preferred embodiment of the present application the housing is equipped with a displaceable annular member. Changing the annular member's position will change the magnetic field and the saturation inside the housing. Thus, the magnetic attraction force between the pin and the disk of the trip unit can be adjusted from the outside of the trip unit. In other words the annular member can be used for calibrating the magnetic forces acting inside the trip unit.

In yet another embodiment the coil core material is iron, which is cost effective compared to the prevalently used FeNi 50-50.

### BRIEF DESCRIPTION OF THE DRAWINGS

FIG. 1 shows a front view of a trip unit for earth leakage detection device;

FIG. 2 is a cross section of a first embodiment of a trip unit wherein an actuator comprising a permanent magnet at the bottom is shown.

FIG. 3 is a cross section of a second embodiment of a trip unit according to the present invention.

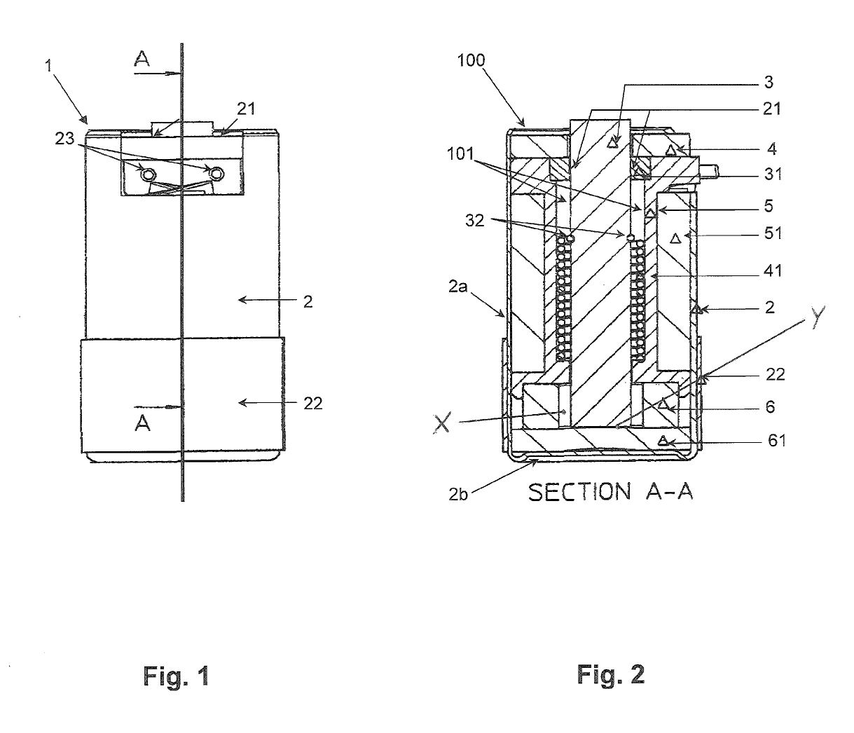

### DETAILED DESCRIPTION OF ILLUSTRATIVE EMBODIMENTS

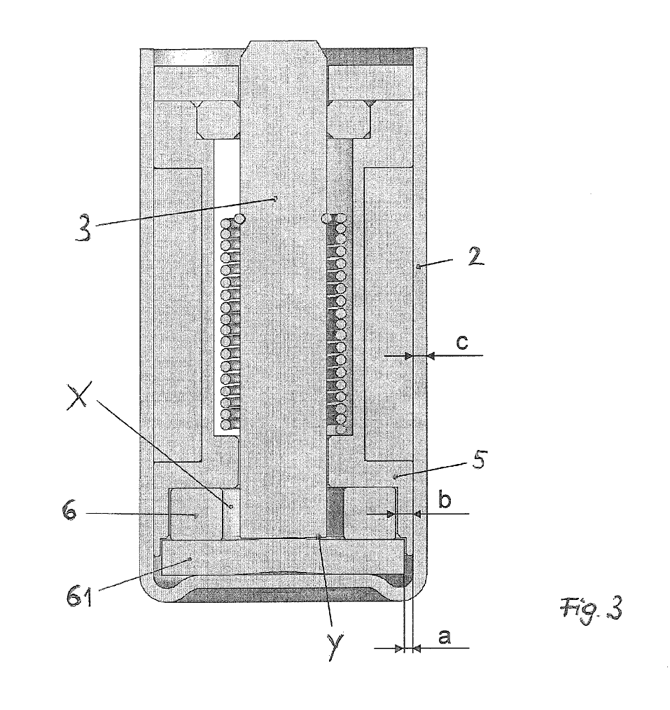

As shown in FIG. 2, a trip unit 1 comprising an actuator 100 and a cylindrical shaped housing 2 is connected to an electrical circuit and detects whether an undesired earth leakage current is present. The housing 2 is generally cup shaped, having a cylindrical wall 2a, an open end and a bottom 2b.

The actuator 100, situated inside the housing 2 is containing a permanent magnet 6 located at the bottom 2b of the housing 2, opposite to the open end of said housing 2. The location of said permanent magnet 6 is thus chosen in this part of the housing 2 to keep contamination parts away from other magnetic surfaces or moving parts inside the actuator. The actuator 100 further comprises a coil housing 5 manufactured from plastic and a coil 51, also being part of the actuator 100. The coil housing 5 and the coil 51 are positioned above the permanent magnet 6. The permanent magnet 6 at least partly surrounds a coil core or pin 3, which is preferably circular cylindrical. Between the pin 3 and the permanent magnet 6 an annular gap X is present. Within this gap X particles that are entering into trip unit 1, such as iron wear particles, are collected. In this way, the iron wear particles are kept away from the contact area Y of the pin 3 with disk 61 near the bottom 2b of the housing 2, thereby maintaining good magnetic flux conditions despite the wear.

The coil housing 5 at least partly defines a closed cylindrical chamber 101 encompassing the pin 3 which is partly disposed and axially movable inside the closed cylindrical chamber 101. Furthermore, the pin 3 has a first end disposed inside the chamber 101, and an opposite second end extending out of the chamber 101. The closed cylindrical chamber 101 is sealed against the environment by a plastic bearing 31, forming a closed end of the closed cylindrical chamber 101 and surrounding the circular pin 3 adjacent to its second end.

Under latched conditions, i.e. when no earth leakage current is present, the circular pin 3, guided by the plastic bearing 31 is held inside the circular chamber 101, abutting against a disk 61, located at the bottom 2b of the housing 2 adjacent to the permanent magnet 6. In order to latch the pin 3 inside the trip unit 1, an axial external force is applied to the pin 3, compressing a biasing means 41, which is preferably a helical spring 41, surrounding the pin 3. The spring 41 is axially oriented and has a first and a second end. The first end abuts against a stationary portion of the actuator 100, for example a shoulder formed by the coil housing 5, close to the bottom of the trip unit 1. The second end is closer to the open end of the housing 2 and is attached to the pin 3 by engaging an annular groove 32. When the trip unit 1 is released, the spring 41 expands towards the open end of the housing 2, moving the pin 3 into a released position. In the released position, the first end of the pin 3 is spaced from the disk 61.

As will be understood, the pin 3 is biased to move outside through the open end of the housing 2 as a result of the stored spring energy of the spring 41 generated by a spring force which is transmitted to the pin 3 by the connection between pin 3 and spring 41. As explained, the second end of the spring 41 is attached to the pin 31 by engaging a pin groove 32 enabling a force transmission, and the first end of the spring 41 is supported by the coil housing 5.

Under the above mentioned latched conditions the pin 3 is held in said condition of the trip unit 1 by an attraction force resulting from a magnetic field which is created by the permanent magnet 6. This attraction force is present between the pin 3 and the disk 61, substituting the aforementioned external force, so that the spring 41 is held in the latched condition. The maximum attraction force is only slightly bigger than the spring force so that these forces are almost balanced, and only a very small force (or energy) is required to trip the trip unit. The disk 61 is made of any magnetisable material so as to be able to transmit the magnetic field generated by the permanent magnet 6 and the coil 51 to the pin 3. Furthermore, the disk 61 has a dome shaped centre for improving the contact between the pin 3 and the disk 61. Preferably, the contact between the pin 3 and the disk 61 is a one point contact, which is preferable from a viewpoint of contamination of the actuator. The one point contact ensures that contact, and hence magnetic force, between the disk and the pin remains equal during lifetime of the trip unit.

As soon as an earth leakage current is present it will be detected by means of a detection coil which is part of an electronic circuit connected to the trip unit by means of connectors 23. The electronic circuit provides for the current signal for energising the coil 51 and overcoming the attraction force between the pin 3 and the disk 61.

Thus, the attraction force is reduced by a counter force resulting from the magnetic field which is generated by the coil 51 and originating from the earth leakage current. Subsequently, the spring force presses the circular pin 3 towards outside the open end of the housing 2. This forced motion of the pin 3 is guided by the plastic bearing 31 near the second end of the pin 3 and therefore the pin 3 conducts a linear movement axially along the mentioned direction out of the closed cylindrical chamber 101.

Once the spring energy is released it is used to trigger, for instance, a switch mechanism that opens the electrical circuit where the fault has occurred.

An annular member 22, which extends around the housing 2 and is axially displaceable on the housing 2, provides the possibility to adjust a level of actuation, so that a displaced annular member 22 results in a corresponding adjusted magnetic field and saturation inside the cylindrical housing 2 and therefore provides for a corresponding adjusted pin attraction force. The annular member 22 and the housing 2 are made of any magnetisable material, preferably iron or steel. Hence, the annular member 22 and the housing 2 form part of the magnetic system.

The housing 2 itself is preferably generally circular cylindrical. The housing 2 may be produced by deep drawing and has a preferably circular cylindrical side wall 2a and a bottom 2b. After inserting the actuator 100 into the housing 2, the open end of the housing 2 may be closed by applying a ring 4, preferably made of steel, around the pin 3 above the coil housing 51 and the plastic bearing 31 and crimping the edge of the housing 2 at its open end over the ring 4.

FIG. 3 shows a second embodiment of a trip unit according to the present invention. The dimensions indicated with “a”, “b” and “c” are important for balancing the magnetic field. This means that the direct coupling of the magnetic field in the housing (2) can be determined by selecting the diameter of the magnet (6). The same applies to the disc (61): by selecting the diameter of the disk (61), the amount of direct coupling of magnetic field will be determined. This will preset the point of magnetic saturation in the housing (2). The magnetic saturation in the housing (2) also depends on the wall thickness “c” of the housing. This makes it possible to correct the magnetic field distribution/balance in the design, so that the maximum available coil energy is always sufficient to trip the tripping unit. The annular member (22) as described above may also be provided to the embodiment shown in FIG. 3. This annular member (22) allows for making adjustments to the actuation level after assembly of the trip unit.

What is claimed is:

1.-13. (canceled)

14. A trip unit, comprising:
an actuator, including:
a cylindrical pin;
a cylindrical closed chamber, said pin being axially movably disposed in said chamber and extending out of said chamber through a sealed opening;
a biasing member, the biasing member configured to bias said pin for an axial movement in a direction out of said chamber;
a permanent magnet at least partly surrounding the pin during a latched condition of said trip unit;
a coil housing at least partly defining said cylindrical closed chamber;
a coil supported by said coil housing; and
a cylindrical housing, containing the actuator, wherein an annular gap is provided between the pin and the permanent magnet.

15. The trip unit according to claim 14, wherein a disk is provided at the bottom of said housing adjacent to said permanent magnet.

16. The trip unit according to claim 15, wherein the disk is provided between the permanent magnet and the bottom of the housing.

17. The trip unit according to claim 14, wherein the outer diameter of the disk is larger than the inner diameter of the permanent magnet.

18. The trip unit according to claim 14, wherein the disk has a dome shaped center for contacting the pin.

19. The trip unit according to claim 18, wherein the contact between the pin and the disk is a one point contact.

20. The trip unit according to claim 15, wherein the disk, the pin, or both the disk and pin are comprised of iron.

21. The trip unit according to claim 14, including an annular member disposed around the housing, said annular member being axially displaceable on the housing.

22. The trip unit according to claim 14, wherein the permanent magnet and pin are circular.

23. The trip unit according to claim 14, wherein the biasing member comprises a spring.

24. The trip unit according to claim 14, wherein the biasing member comprises a helical spring, surrounding said pin inside the housing and being attached to said pin by engagement into an annular groove provided in said pin.

25. The trip unit according to claim 14, wherein the pin has a first end disposed inside said chamber and an opposite second end extending out of said chamber through the opening, wherein the permanent magnet is positioned at the first end of said pin.

26. The trip unit according to claim 14, wherein the trip unit is an earth leakage detection device configured to switch off a mechanism or load.

27. A trip unit comprising:
an actuator, including:
a cylindrical pin;
a cylindrical closed chamber, said pin being axially movably disposed in said chamber and extending out of said chamber through a sealed opening,
a biasing means for biasing said pin for an axial movement in a direction out of said chamber;
a permanent magnet at least partly surrounding the pin during a latched condition of said trip unit;
a coil housing at least partly defining said cylindrical closed chamber;
a coil supported by said coil housing; and
a cylindrical housing, containing the actuator, wherein the trip unit further comprises an annular member disposed around the housing, said annular member being axially displaceable on the housing.

28. A method for manufacturing a trip unit, the method comprising:
providing a cylindrical, generally cup-shaped housing, having a cylindrical side wall, a bottom at a closed end, and an open end opposite to said closed end,
inserting an actuator into the housing, and
crimping the open end of said housing about said actuator.
